(19) United States
(12) Patent Application Publication
(10) Pub. No.: US 2025/0022051 A1
(43) Pub. Date: Jan. 16, 2025

(54) METHOD AND SYSTEM FOR PROVIDING NEWS RISK ALERTS FOR WHOLESALE CREDIT RISK MANAGEMENT

(71) Applicant: JPMorgan Chase Bank, N.A., New York, NY (US)

(72) Inventors: Glen Lawrence NORONHA, Plano, TX (US); Yunfeng ZHU, Shanghai (CN); Joe HALLIWELL, Glasgow (GB); Adil NYGAARD, Glasgow (GB); Sandeep YERAPOTINA, Westerville, OH (US); Ian BROWN, Glasgow (GB); Florenz Allewijn Pieter HOLLEBRANDSE, Glasgow (GB)

(73) Assignee: JPMorgan Chase Bank, N.A., New York, NY (US)

(21) Appl. No.: 18/221,596

(22) Filed: Jul. 13, 2023

(51) Int. Cl. G06Q 40/03

(52) U.S. Cl. CPC G06Q 40/03

(57) ABSTRACT

A method and a system for delivering real-time alerts about significant news events to various recipients in order to facilitate assessments for managing wholesale credit risk are provided. The method includes: receiving a news article that relates to an entity; applying a model that uses a Natural Language Processing (NLP) technique to analyze the news article in order to determine whether the news article contains important content, such as negative information or information that relates to merger and acquisition (M&A) activity; when a determination is made that the news article contains important content, generating an alert message that includes a notification that the news article contains important content; and transmitting the alert message and information that corresponds to the news article to interested parties.

### BACKGROUND

### 1. Field of the Disclosure

This technology generally relates to methods and systems for delivering real-time alerts about significant news events to various recipients in order to facilitate assessments for managing wholesale credit risk.

### 2. Background Information

For a large financial institution, many business decisions, such as decisions regarding whether to extend credit to applicants, are made by many different groups on a daily basis. Such decisions are based in part on news information that is continuously generated by a large number of global news sources.

Credit officers need to monitor news about clients in their portfolio in order to manage the associated risk appropriately. Many credit officers have large numbers of clients, and the news items that relate to such clients is of varying newsworthiness, and as a result, monitoring the news can be time-consuming and difficult to perform on an ongoing basis.

Accordingly, there is a need for systems and methods that are designed to delivering real-time alerts about significant news events to various recipients in order to facilitate assessments for managing wholesale credit risk.

### SUMMARY

The present disclosure, through one or more of its various aspects, embodiments, and/or specific features or sub-components, provides, inter alia, various systems, servers, devices, methods, media, programs, and platforms for delivering real-time alerts about significant news events to various recipients in order to facilitate assessments for managing wholesale credit risk.

According to an exemplary embodiment, a method for managing a credit risk with respect to an entity is provided. The method includes: receiving, by the at least one processor, a news article that relates to the entity; analyzing, by the at least one processor, the news article in order to determine whether the news article contains important content; when a determination is made that the news article contains important content as a result of the analyzing, generating, by the at least one processor, an alert message that includes a notification that the news article contains important content; and transmitting, by the at least one processor to a predetermined destination, the alert message and information that corresponds to the news article such that a user interface associated with the predetermined destination is caused to display the transmitted information.

The analyzing may include determining whether the news article contains information that is negative with respect to the entity. When a determination is made that the news article contains information that is negative with respect to the entity, the information that is negative with respect to the entity may be determined as being important content.

The analyzing may include determining whether the news article contains information that relates to merger and acquisition (M&A) activity with respect to the entity. When a determination is made that the news article contains information that relates to M&A activity with respect to the entity, the information that relates to M&A activity with respect to the entity may be determined as being important content.

The analyzing may include applying a first model that uses a Natural Language Processing (NLP) technique to analyze the news article.

The alert message may further include a name of the entity, an alert date, an alert description, and information that relates to a relevance of the news article to a credit risk profile associated with the entity.

The method may further include prompting a user to respond to the alert message by transmitting a prompt message to the predetermined destination such that the user interface is caused to display the prompt message. The prompt message may include information indicating that a response to the alert message is required to be generated within a predetermined time interval.

The news article may be received via a Dow Jones Factiva news aggregation service.

The news article may be originated by at least one source from among a plurality of sources that includes at least one from among Dow Jones, Lexis Nexis, Bloomberg, Twitter, JPMorgan Markets, Refinitiv, Wall Street Journal, Financial Times, and SNL Financial.

The method may further include assigning a category to the news article based on a result of the analyzing. The category may include at least one from among a first category that corresponds to an analyst commentary, a second category that corresponds to debt financing, a third category that corresponds to bankruptcy and financial distress, a fourth category that corresponds to dividends and buybacks, and a fifth category that corresponds to credit ratings.

According to another exemplary embodiment, a computing apparatus for managing a credit risk with respect to an entity is provided. The computing apparatus includes a processor; a memory; and a communication interface coupled to each of the processor and the memory. The processor is configured to: receive, via the communication interface, a news article that relates to the entity; analyze the news article in order to determine whether the news article contains important content; when a determination is made that the news article contains important content as a result of the analysis, generate an alert message that includes a notification that the news article contains important content; and transmit, via the communication interface to a predetermined destination, the alert message and information that corresponds to the news article such that a user interface associated with the predetermined destination is caused to display the transmitted information.

The processor may be further configured to determine whether the news article contains information that is negative with respect to the entity. When a determination is made that the news article contains information that is negative with respect to the entity, the information that is negative with respect to the entity may be determined as being important content.

The processor may be further configured to determine whether the news article contains information that relates to merger and acquisition (M&A) activity with respect to the entity. When a determination is made that the news article contains information that relates to M&A activity with respect to the entity, the information that relates to M&A activity with respect to the entity may be determined as being important content.

The processor may be further configured to apply a first model that uses a Natural Language Processing (NLP) technique to analyze the news article.

The alert message may further include a name of the entity, an alert date, an alert description, and information that relates to a relevance of the news article to a credit risk profile associated with the entity.

The processor may be further configured to prompt a user to respond to the alert message by transmitting a prompt message to the predetermined destination such that the user interface is caused to display the prompt message. The prompt message may include information indicating that a response to the alert message is required to be generated within a predetermined time interval.

The news article may be received via a Dow Jones Factiva news aggregation service.

The news article may be originated by at least one source from among a plurality of sources that includes at least one from among Dow Jones, Lexis Nexis, Bloomberg, Twitter, JPMorgan Markets, Refinitiv, Wall Street Journal, Financial Times, and SNL Financial.

The processor may be further configured to assign a category to the news article based on a result of the analysis. The category may include at least one from among a first category that corresponds to an analyst commentary, a second category that corresponds to debt financing, a third category that corresponds to bankruptcy and financial distress, a fourth category that corresponds to dividends and buybacks, and a fifth category that corresponds to credit ratings.

According to yet another exemplary embodiment, a non-transitory computer readable storage medium storing instructions for managing a credit risk with respect to an entity is provided. The storage medium includes executable code which, when executed by a processor, causes the processor to: receive a news article that relates to the entity; analyze the news article in order to determine whether the news article contains important content; when a determination is made that the news article contains important content as a result of the analyzing, generate an alert message that includes a notification that the news article contains important content; and transmit, to a predetermined destination, the alert message and information that corresponds to the news article such that a user interface associated with the predetermined destination is caused to display the transmitted information.

The executable code may be further configured to cause the processor to apply a first model that uses a Natural Language Processing (NLP) technique to analyze the news article.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for delivering real-time alerts about significant news events to various recipients in order to facilitate assessments for managing wholesale credit risk.

FIG. 4 is a flowchart of an exemplary process for implementing a method for delivering real-time alerts about significant news events to various recipients in order to facilitate assessments for managing wholesale credit risk.

FIG. 5 is a logic data flow diagram that illustrates components and data flow for a system that is configured to deliver real-time alerts about significant news events to various recipients in order to facilitate assessments for managing wholesale credit risk, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

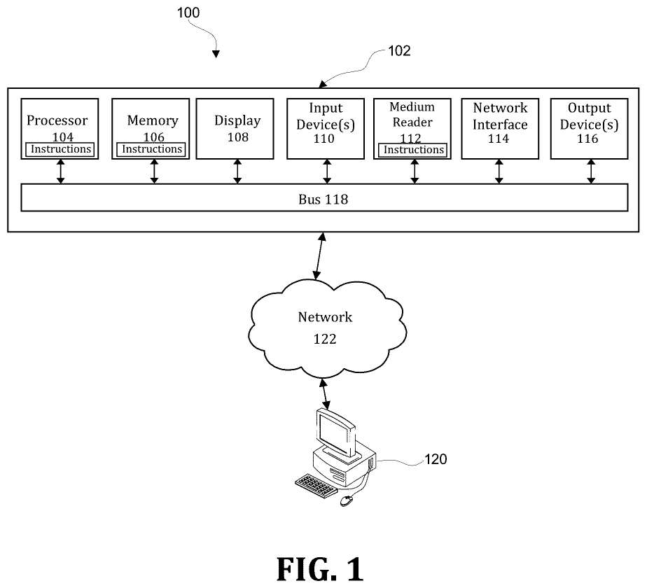

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for delivering real-time alerts about significant news events to various recipients in order to facilitate assessments for managing wholesale credit risk.

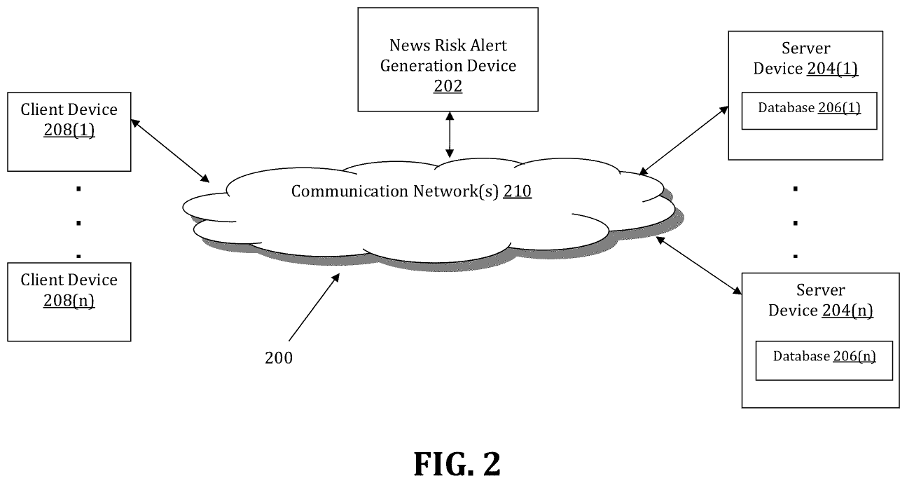

Referring to FIG. 2, a schematic of an exemplary network environment 200 for implementing a method for delivering real-time alerts about significant news events to various recipients in order to facilitate assessments for managing wholesale credit risk is illustrated. In an exemplary embodiment, the method is executable on any networked computer platform, such as, for example, a personal computer (PC).

The method for delivering real-time alerts about significant news events to various recipients in order to facilitate assessments for managing wholesale credit risk may be implemented by a News Risk Alert Generation (NRAG) device 202. The NRAG device 202 may be the same or similar to the computer system 102 as described with respect to FIG. 1. The NRAG device 202 may store one or more applications that can include executable instructions that, when executed by the NRAG device 202, cause the NRAG device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the NRAG device 202 itself, may be located in virtual server(s) running in a cloud-based computing environment rather than being tied to one or more specific physical network computing devices. Also, the application(s) may be running in one or more virtual machines (VMs) executing on the NRAG device 202. Additionally, in one or more embodiments of this technology, virtual machine(s) running on the NRAG device 202 may be managed or supervised by a hypervisor.

In the network environment 200 of FIG. 2, the NRAG device 202 is coupled to a plurality of server devices 204(1)-204(n) that hosts a plurality of databases 206(1)-206(n), and also to a plurality of client devices 208(1)-208(n) via communication network(s) 210. A communication interface of the NRAG device 202, such as the network interface 114 of the computer system 102 of FIG. 1, operatively couples and communicates between the NRAG device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the NRAG device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and NRAG devices that efficiently implement a method for delivering real-time alerts about significant news events to various recipients in order to facilitate assessments for managing wholesale credit risk.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The NRAG device 202 may be a standalone device or integrated with one or more other devices or apparatuses, such as one or more of the server devices 204(1)-204(n), for example. In one particular example, the NRAG device 202 may include or be hosted by one of the server devices 204(1)-204(n), and other arrangements are also possible. Moreover, one or more of the devices of the NRAG device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the NRAG device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store raw news data, entity-specific data, and Natural Language Processing (NLP) model information that is usable for identifying, organizing, categorizing, prioritizing, and summarizing credit-relevant news articles.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the NRAG device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the NRAG device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the NRAG device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the NRAG device 202, the server devices 204(1)-204(n), or the client devices 208(1)-208(n), for example, may be configured to operate as virtual instances on the same physical machine. In other words, one or more of the NRAG device 202, the server devices 204(1)-204(n), or the client devices 208(1)-208(n) may operate on the same physical device rather than as separate devices communicating through communication network(s) 210. Additionally, there may be more or fewer NRAG devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

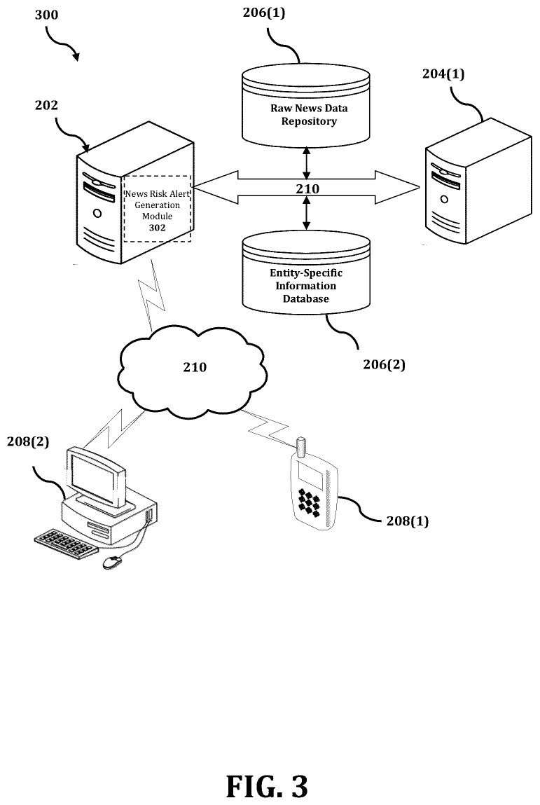

The NRAG device 202 is described and shown in FIG. 3 as including a news risk alert generation module 302, although it may include other rules, policies, modules, databases, or applications, for example. As will be described below, the news risk alert generation module 302 is configured to implement a method for delivering real-time alerts about significant news events to various recipients in order to facilitate assessments for managing wholesale credit risk in an automated, efficient, scalable, and reliable manner.

An exemplary process 300 for implementing a method for delivering real-time alerts about significant news events to various recipients in order to facilitate assessments for managing wholesale credit risk by utilizing the network environment of FIG. 2 is shown as being executed in FIG. 3. Specifically, a first client device 208(1) and a second client device 208(2) are illustrated as being in communication with NRAG device 202. In this regard, the first client device 208(1) and the second client device 208(2) may be “clients” of the NRAG device 202 and are described herein as such. Nevertheless, it is to be known and understood that the first client device 208(1) and/or the second client device 208(2) need not necessarily be “clients” of the NRAG device 202, or any entity described in association therewith herein. Any additional or alternative relationship may exist between either or both of the first client device 208(1) and the second client device 208(2) and the NRAG device 202, or no relationship may exist.

Further, NRAG device 202 is illustrated as being able to access a raw news data repository 206(1) and an entity-specific information database 206(2). The news risk alert generation module 302 may be configured to access these databases for implementing a method for delivering real-time alerts about significant news events to various recipients in order to facilitate assessments for managing wholesale credit risk.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the NRAG device 202 via broadband or cellular communication. Of course, these embodiments are merely exemplary and are not limiting or exhaustive.

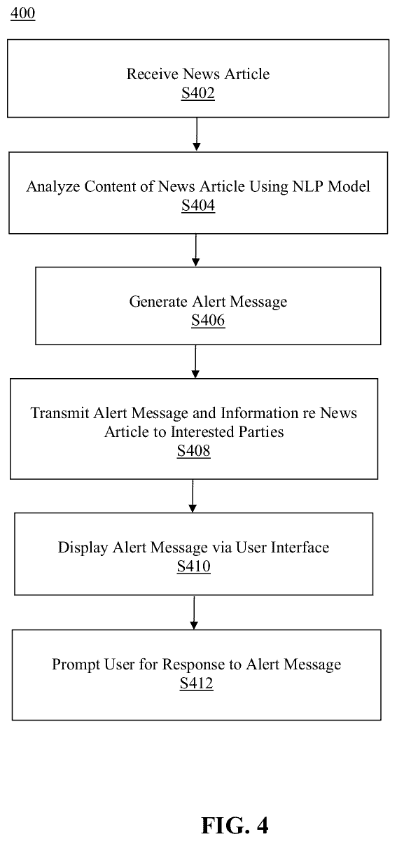

Upon being started, the news risk alert generation module 302 executes a process for delivering real-time alerts about significant news events to various recipients in order to facilitate assessments for managing wholesale credit risk. An exemplary process for delivering real-time alerts about significant news events to various recipients in order to facilitate assessments for managing wholesale credit risk is generally indicated at flowchart 400 in FIG. 4.

In the process 400 of FIG. 4, at step S402, the news risk alert generation module 302 receives a news article that relates to an entity. In an exemplary embodiment, the entity may be a client of a financial institution, such as a bank, and the bank may be interested in managing a wholesale credit risk with respect to the client, in order to make wise decisions regarding whether to extend credit to the client. In an exemplary embodiment, the news article may be received via a news aggregation service, such as, for example, the Dow Jones Factiva news aggregation service. The news article may be originated by at least one source from among a plurality of sources that includes any one or more of Dow Jones, Lexis Nexis, Bloomberg, Twitter, JP Morgan Markets, Refinitiv, the Wall Street Journal, the Financial Times, SNL Financial, and/or any other reputable source of economic news.

At step S404, the news risk alert generation module 302 analyzes the news article in order to determine whether the news article contains important content. In an exemplary embodiment, the analysis is performed by applying a model that uses a Natural Language Processing (NLP) technique to analyze the news article.

In an exemplary embodiment, the model is configured to determine whether the news article contains negative information about the entity, and also to determine whether the news article contains information that relates to merger and acquisition (M&A) activity with respect to the entity. When either negative information or M&A information is included in the news article, then the model may be configured to determine such information as being important content.

As a result of the analysis performed in step S404, the news risk generation module 302 may assign a category to the news article. In an exemplary embodiment, the category may include any one of more of a first category that corresponds to an analyst commentary, a second category that corresponds to debt financing, a third category that corresponds to bankruptcy and financial distress, a fourth category that corresponds to dividends and buybacks, and a fifth category that corresponds to credit ratings.

At step S406, when the news article is determined as containing important content, the news risk alert generation module 302 generates an alert message that includes a notification that the news article contains important content. In an exemplary embodiment, the alert message may also include a name of the entity, an alert date, an alert description, and information that relates to a relevance of the news article to a credit risk profile associated with the entity.

At step S408, the news risk alert generation module 302 transmits the alert message and information that corresponds to the news article to one or more predetermined destinations that correspond to interested parties. Then, at step S410, the news risk alert generation module 302 causes a user interface associated with the respective destination to display the transmitted information, so that a user is easily able to see the alert message. In an exemplary embodiment, the information that corresponds to the news article may include the entire text of the news article and/or a clickable link that facilitates an ability of the user to access the news article.

At step S412, the news risk alert generation module 302 prompts the user to respond to the alert message by transmitting a prompt message to each predetermined destination such that the respective user interface displays the prompt message. In an exemplary embodiment, the prompt message includes information indicating that a response to the alert message is required to be generated within a predetermined time interval, such as, for example, one business day, one week, or one month.

In an exemplary embodiment, a wholesale credit risk team within a financial institution, such as a bank, is responsible for assessing and managing the credit risk associated with credit exposure to wholesale clients. Key functional tasks performed by the team may include, for example, any one or more of annual reviews, risk grading, limits management, credit underwriting and providing credit risk oversight for transactions. The team may handle credit risk management of products such as commercial card, line of credit, loan, automated clearing house, intra-day limit, and various other products. The team may cover various types of wholesale clients, such as, for example, corporate clients, government clients, nonprofit clients, and any other type of client, and the scope may be global. The team may partner with various internal and external stakeholders while executing their credit risk responsibilities.

In an exemplary embodiment, as part of their day-to-day activities, credit officers within a wholesale credit risk team may analyze various internal and external data sources when making credit risk decisions. Some of these data sources include client financials, market information, supply chain distribution, research reports, news feed, etc. Historically, news was consumed by manually configuring a customized news feed or by browsing across multiple news websites (e.g., Wall Street Journal, Financial Times, SNL, Bloomberg, etc.) and searching for client-specific news.

Given the manually intensive nature of this process, in an exemplary embodiment, an automated news delivery solution is designed to surface relevant news to credit officers proactively and save them time in day-to-day risk decision making. Key features of this solution include the following: 1) Credit officers receive a daily news digest (i.e., via email) that includes curated news for clients in their credit coverage hierarchy. 2) News can also be accessed through a client dashboard in an Integrated Credit Risk Desktop (ICRD). 3) The solution leverages Dow Jones Factiva as the underlying data source for aggregating news across thousands of individual sources globally. 4) Ability to view news for specific key credit-relevant topics, such as Debt Financing, Credit Ratings, Bankruptcy, etc. 5) Similar articles from different sources are grouped together and displayed in a “Related News” section under the primary article. 6) Access to the full content of the news article is also provided.

In an exemplary embodiment, during the periodic or off-cycle credit review process, credit officers analyze various internal and external sources of information to evaluate the credit risk of clients. They use this information in alignment with an internal risk grading methodology to determine the credit risk rating for a client and/or facility. As a result of this exercise, a client's credit rating could either worsen (downgrade), improve (upgrade) or stay the same (no change).

In an exemplary embodiment, for the purpose of analysis, downgrades may be classified into three categories: 1) Financial: This type of downgrade is based on deterioration in financial metrics as evidenced by client's financial statements and/or financial projections. 2) Event: This type of downgrade is based on known or potential impact from events like M&A, litigation, production issues, supply chain challenges, raw material shortage, etc. 3) Mixed: This type of downgrade has attributes of both “financial” and “event” driven downgrades.

In an exemplary embodiment, it is hypothesized that news related to events pre-dates “event” and “mixed” type of downgrades. With the exception of M&A, most events that influence subsequent downgrades are negative from a sentiment perspective. Therefore, it is beneficial to have a model or analytical solution that associates sentiment with news articles and determines whether an alert should be raised to the credit officer for further review and analysis of the negative event. Similarly, since M&A events are not typically considered negative from a sentiment perspective, it is preferable to have a model or analytical solution to alert credit officers to M&A events.

Having a systemic solution for event-related alerts has the following advantages: 1) A systemic solution generates an alert based on the intensity of the negative event as determined by the sentiment score and volume of negative news over time. 2) Model parameters can be controlled to optimize for alerting volume, precision and recall for client downgrades. 3) The event is memorialized by recording it as an alert and can be used in credit risk analysis over time. 4) Credit officers are alerted about the event and are expected to review and close out the alert in the system by selecting the appropriate closure option. 5) The systemic solution saves time and effort for credit officers by providing relief from having to manually review news articles and determine whether or not each article is worthy of an alert.

In an exemplary embodiment, when a credit officer receives an alert, the credit officer is expected to review the alert and select from one of the following options to respond to the alert: 1) Event irrelevant to client's credit risk profile; 2) Impact considered in recent client review or grading action; 3) Impact mitigated by client's overall financial strength; 4) Impact mitigated by adequate guarantor/collateral support; 5) Impact mitigated by other factors (comments required); and 6) Event represents new information to be considered in upcoming rating review process. In an exemplary embodiment, if a credit officer selects any option other than “1”, then the alert is considered a “good” alert.

In an exemplary embodiment, the following metrics are tracked for the model output: 1) Precision: Of all the alerts that were generated, how many were “good” alerts? The model should have a precision of at least 50%. Feedback from the Credit Officers is used to adjust model parameters and re-train or update the model as required.

2) Volume: Since the purpose of the system is to surface only the significant negative or M&A events from a vast corpus of news articles, the volume of news alerts should be optimal. Without recommending a minimum or maximum threshold, the model strives to ensure that all major negative or M&A events that affect the client's risk profile are identified by the system and that an appropriate alert is generated for such events.

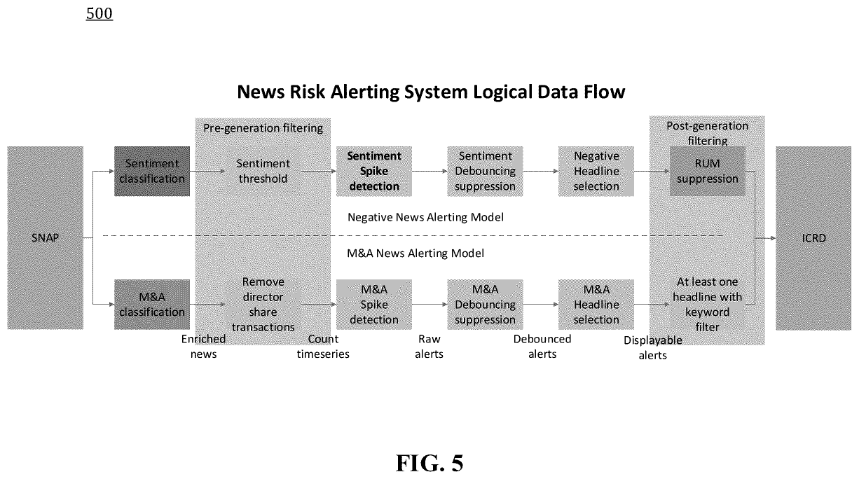

Model Formulation: FIG. 5 is a logic data flow diagram 500 that illustrates components and data flow for a system that is configured to deliver real-time alerts about significant news events to various recipients in order to facilitate assessments for managing wholesale credit risk, according to an exemplary embodiment.

The system illustrated in FIG. 5 comprises two similar but separate and completely independent alerting subsystems (or “legs”): one for alerting on negative news about wholesale credit risk clients, and the other for alerting on mergers and acquisition (M&A) activity involving wholesale credit risk clients. Both legs operate on news articles collected, evaluated, and analyzed by a Shared News Analytics Platform (SNAP), and generate alerts that feed into an Integrated Credit Risk Desktop (ICRD). The news alerts are generated on a per-company, per-day basis as needed and are shown to credit risk officers whose portfolio includes that company. It is possible for two alerts to be generated on the same day for the same company, one originating from each leg.

Both legs consist of several sub-models trained on sub-tasks. These are combined using heuristic rules with parameters derived from back-testing and experimentation through a pilot period.

In an exemplary embodiment, the system includes five primary components: 1) Sentiment Model, 2) Sentiment Alerting Subsystem, 3) Routine Update on Markets (RUM) Detector, 4) M&A Model, and 5) M&A Alerting Subsystem. The first three components compose the Sentiment Leg of the system, while the latter two make up the M& A Leg.

Sentiment Model: In an exemplary embodiment, the company sentiments analytic provides a sentiment score for each company mentioned in the headline of a story. Scores range from −1 (i.e., very negative) to +1 (i.e., very positive). The sentiment analysis is targeted; as such, different companies mentioned in the same headline may have different scores. The Sentiment Model is a deep learning neural network model built from the pre-trained BERT model known as “bert-base-uncased” and fine-tuned with labeled data.

Sentiment Alerting Subsystem: In an exemplary embodiment, to help identify when credit officers might need to review companies in their portfolio, a pro-active alerting system is based on the sentiment associated with the company as mentioned in news articles. The system generates alerts that consist of the news articles with the most negative associated sentiment for a specific company for a particular day.

There are three inputs into the Sentiment Alerting Subsystem. The first is a timeseries of historic sentiment scores for the company of interest. The second is the list of articles, with headline and sentiment score, from the past 24 hours about the company of interest. The final input is the most recent sentiment alert published about the company.

The Sentiment Alerting Subsystem has the following steps: 1) Negative count timeseries: For each company in a credit officer's portfolio, a timeseries of the volume of negative news over the past 90 days is generated. This is used to determine a baseline value for comparison with the last day's news. 2) Volume spike detection: Alerts are only generated when there is an elevated amount of negative news about a particular company. This step checks that the volume of negative news in the last 24 hours is sufficiently higher than baseline news to warrant an alert. 3) Debouncing suppression: This step ensures that multiple alerts are not generated for a single event as additional news outlets produce articles about it. If an alert has recently been published for the company of interest, additional alerts are temporarily suppressed. 4) Alert headline selection: The goal of this step is to select the best article headlines to include in the alert so that it is clearly relevant to receiving analysts. This step includes a post-generation filter which uses a rule-based Routine Update on Markets (RUM) detector to improve precision by suppressing several classes of false positive associated with market news (i.e., price drops) and other routine negative news. In an exemplary embodiment, this filter is applied post-alert generation but pre-publishing, i.e., before the alert is displayed and sent to credit risk officers.

The output of the Sentiment Alerting Subsystem, if a sufficient volume of negative news exists, is a sentiment alert with a list of the most relevant headlines.

RUM Detector: In an exemplary embodiment, the system sends out alerts for companies with a relatively higher-than-average volume of negative news articles in a particular day. Sometimes, these alerts are composed of news articles primarily about stock price changes, market performance, stock price targets, or an analyst's predictive evaluation of stock performance. Many of these articles tend to originate from publications which produce articles with template headlines, with the only change being the specific stock and the market performance.

These Routine Update on Markets (RUM) articles are generally assigned very low sentiment scores and are therefore over-represented in the negative news about a particular company for a particular day. For most cases, these news articles do not provide pertinent or germane information for the credit risk assessment for a company. Therefore, the system is designed to filter or remove alerts that primarily consist of RUM articles.

M&A Model: In an exemplary embodiment, the Mergers and Acquisitions (M&A) Model assigns an M&A score to each news article. Scores range from 0.0 (i.e., very unlikely to be about an M&A event) to 1.0 (i.e., very likely to be about an M&A event). Scores are associated with an article and, unlike the Sentiment Model, are not targeted. Any company mentioned in the article is associated with the M& A score.

As illustrated in logical flow diagram 500, the M&A Model operates on news articles processed by SNAP and produces data used by the M&A Alerting Subsystem to determine whether an alert should be generated about the news event in the ICRD dashboard. Like the Sentiment Model, the M&A Model is a deep learning neural network model built from the pre-trained BERT model “bert-base-uncased” and fine-tuned with labeled data.

M&A Alerting Subsystem: In an exemplary embodiment, the goal of the M&A Alerting Subsystem is to identify news events about companies of interest to alert credit risk analysts for further review. The M&A Leg tracks news related to mergers and acquisitions and determines when an alert should be sent to the appropriate analyst in the Integrated Credit Risk Desktop (ICRD).

After news articles have been processed by SNAP and an M&A score generated by the M&A Classifier, the M&A Alerting Subsystem determines whether, for a given company and date, an alert should be generated. If an alert is generated, it is sent to the ICRD dashboard, where end users must respond to the alert. Alerts are generated on a per-company, per-day basis when a sufficiently large volume of articles that mention that company and have been classified as M&A are published in one day.

In an exemplary embodiment, there are three inputs into the M&A Alerting Subsystem. The first is a timeseries of historic volume counts of M&A articles mentioning the company of interest. The second is the list of articles, with headline and M&A score, from the past 24 hours about the company of interest. The final input is the most recent M&A alert published about the company.

In an exemplary embodiment, the M&A Alerting Subsystem has the following steps: 1) Filtering: This step retains only relevant M&A headlines. This is necessary to determine the daily volume, which is also used in future timeseries, and to select relevant headlines, if necessary, for the alert for this day. 2) Volume spike detection: This step checks that the volume of M&A news about the company of interest in the last 24 hours is sufficiently higher than baseline news to warrant an alert. 3) Debouncing suppression: If a sentiment alert has recently been published for the company of interest, additional alerts are temporarily suppressed. 4) Alert headline selection: The goal of this step is to select the best article headlines to include in the alert so that it is clearly relevant to receiving analysts. 5) Relevancy filter: This step guarantees that generated alerts have at least one headline that specifies the nature of the event, such as, for example, merger, acquisition, or takeover.

The output of the M&A Alerting Subsystem, if a sufficient volume of M&A news exists, is an alert with a list of the most relevant headlines. In an exemplary embodiment, the M&A Alerting Subsystem may process a relatively large volume of articles, such as, for example, hundreds of thousands of articles per day, and may generate alerts for less than one percent, i.e., approximately 0.1%-0.5% of the articles. In an exemplary embodiment, the M&A Alerting Subsystem covers thousands of companies and other commercial entities across a global wholesale credit risk portfolio. In addition, the M&A Alerting Subsystem uses the responses selected by end users to adjust and fine-tune system parameters in order to improve overall system performance.

Accordingly, with this technology, an optimized process for delivering real-time alerts about significant news events to various recipients in order to facilitate assessments for managing wholesale credit risk is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for managing a credit risk with respect to an entity, the method being implemented by at least one processor, the method comprising:
receiving, by the at least one processor, a news article that relates to the entity;
analyzing, by the at least one processor, the news article in order to determine whether the news article contains important content;
when a determination is made that the news article contains important content as a result of the analyzing, generating, by the at least one processor, an alert message that includes a notification that the news article contains important content; and
transmitting, by the at least one processor to a predetermined destination, the alert message and information that corresponds to the news article such that a user interface associated with the predetermined destination is caused to display the transmitted information.

2. The method of claim 1, wherein the analyzing comprises determining whether the news article contains information that is negative with respect to the entity, and
wherein when a determination is made that the news article contains information that is negative with respect to the entity, the information that is negative with respect to the entity is determined as being important content.

3. The method of claim 1, wherein the analyzing comprises determining whether the news article contains information that relates to merger and acquisition (M&A) activity with respect to the entity, and
wherein when a determination is made that the news article contains information that relates to M&A activity with respect to the entity, the information that relates to M&A activity with respect to the entity is determined as being important content.

4. The method of claim 1, wherein the analyzing comprises applying a first model that uses a Natural Language Processing (NLP) technique to analyze the news article.

5. The method of claim 1, wherein the alert message further includes a name of the entity, an alert date, an alert description, and information that relates to a relevance of the news article to a credit risk profile associated with the entity.

6. The method of claim 1, further comprising prompting a user to respond to the alert message by transmitting a prompt message to the predetermined destination such that the user interface is caused to display the prompt message,
wherein the prompt message includes information indicating that a response to the alert message is required to be generated within a predetermined time interval.

7. The method of claim 1, wherein the news article is received via a Dow Jones Factiva news aggregation service.

8. The method of claim 1, wherein the news article is originated by at least one source from among a plurality of sources that includes at least one from among Dow Jones, Lexis Nexis, Bloomberg, Twitter, JPMorgan Markets, Refinitiv, Wall Street Journal, Financial Times, and SNL Financial.

9. The method of claim 1, further comprising assigning a category to the news article based on a result of the analyzing,
wherein the category includes at least one from among a first category that corresponds to an analyst commentary, a second category that corresponds to debt financing, a third category that corresponds to bankruptcy and financial distress, a fourth category that corresponds to dividends and buybacks, and a fifth category that corresponds to credit ratings.

10. A computing apparatus for managing a credit risk with respect to an entity, the computing apparatus comprising:
a processor;
a memory; and
a communication interface coupled to each of the processor and the memory, wherein the processor is configured to:
receive, via the communication interface, a news article that relates to the entity;
analyze the news article in order to determine whether the news article contains important content;
when a determination is made that the news article contains important content as a result of the analysis, generate an alert message that includes a notification that the news article contains important content; and
transmit, via the communication interface to a predetermined destination, the alert message and information that corresponds to the news article such that a user interface associated with the predetermined destination is caused to display the transmitted information.

11. The computing apparatus of claim 10, wherein the processor is further configured to determine whether the news article contains information that is negative with respect to the entity, and
wherein when a determination is made that the news article contains information that is negative with respect to the entity, the information that is negative with respect to the entity is determined as being important content.

12. The computing apparatus of claim 10, wherein the processor is further configured to determine whether the news article contains information that relates to merger and acquisition (M&A) activity with respect to the entity, and
wherein when a determination is made that the news article contains information that relates to M&A activity with respect to the entity, the information that relates to M&A activity with respect to the entity is determined as being important content.

13. The computing apparatus of claim 10, wherein the processor is further configured to apply a first model that uses a Natural Language Processing (NLP) technique to analyze the news article.

14. The computing apparatus of claim 10, wherein the alert message further includes a name of the entity, an alert date, an alert description, and information that relates to a relevance of the news article to a credit risk profile associated with the entity.

15. The computing apparatus of claim 10, wherein the processor is further configured to prompt a user to respond to the alert message by transmitting a prompt message to the predetermined destination such that the user interface is caused to display the prompt message,
wherein the prompt message includes information indicating that a response to the alert message is required to be generated within a predetermined time interval.

16. The computing apparatus of claim 10, wherein the news article is received via a Dow Jones Factiva news aggregation service.

17. The computing apparatus of claim 10, wherein the news article is originated by at least one source from among a plurality of sources that includes at least one from among Dow Jones, Lexis Nexis, Bloomberg, Twitter, JPMorgan Markets, Refinitiv, Wall Street Journal, Financial Times, and SNL Financial.

18. The computing apparatus of claim 10, wherein the processor is further configured to assign a category to the news article based on a result of the analysis,
wherein the category includes at least one from among a first category that corresponds to an analyst commentary, a second category that corresponds to debt financing, a third category that corresponds to bankruptcy and financial distress, a fourth category that corresponds to dividends and buybacks, and a fifth category that corresponds to credit ratings.

19. A non-transitory computer readable storage medium storing instructions for managing a credit risk with respect to an entity, the storage medium comprising executable code which, when executed by a processor, causes the processor to:
receive a news article that relates to the entity;
analyze the news article in order to determine whether the news article contains important content;
when a determination is made that the news article contains important content as a result of the analyzing, generate an alert message that includes a notification that the news article contains important content; and
transmit, to a predetermined destination, the alert message and information that corresponds to the news article such that a user interface associated with the predetermined destination is caused to display the transmitted information.

20. The storage medium of claim 19, wherein the executable code is further configured to cause the processor to apply a first model that uses a Natural Language Processing (NLP) technique to analyze the news article.
